(19) United States
(12) Patent Application Publication
(10) Pub. No.: US 2026/0153961 A1
(43) Pub. Date: Jun. 4, 2026

(54) SWITCH APPARATUS, MOBILITY APPARATUS INCLUDING THE SAME, AND CONTROL METHOD OF MOBILITY APPARATUS

(71) Applicants: Hyundai Motor Company, Seoul (KR); Kia Corporation, Seoul (KR)

(72) Inventor: Sang Hoon SHIN, Hwaseong-Si (KR)

(21) Appl. No.: 19/311,420

(22) Filed: Aug. 27, 2025

(30) Foreign Application Priority Data
Dec. 3, 2024 (KR) 10-2024-0177250

(51) Int. Cl. G06F 3/041; B60R 1/07; G06F 3/02; E05F 15/60

(52) U.S. Cl. CPC G06F 3/0418; B60R 1/07; G06F 3/02; E05F 15/60; E05Y 2900/531; E05Y 2900/55

(57) ABSTRACT

A switching apparatus is provided. The switching apparatus may include: a touch sensor configured to generate, based on receiving a touch input, a touch input signal; a tactile switch configured to generate, based on a physical movement of the tactile switch, a tactile input signal; and a control circuit connected to the touch sensor and the tactile switch. The control circuit may be configured to output a switching signal based on at least one of: receiving, within a first threshold time duration, at least a first threshold quantity of touch input signals from the touch sensor; receiving, within a second threshold time duration, at least a second threshold quantity of tactile input signals from the tactile switch; or receiving at least one tactile input signal from the tactile switch within a third threshold time duration after receiving at least one touch input signal from the touch sensor.

### CROSS-REFERENCE TO RELATED APPLICATION

This application claims priority to and the benefit of Korean Patent Application No. 10-2024-0177250, filed in the Korean Intellectual Property Office on December 3, 2024, the disclosure of which is incorporated herein by reference in its entirety.

### TECHNICAL FIELD

The present disclosure relates to a switch apparatus, a mobility apparatus including the same, and a method of controlling the mobility apparatus.

### BACKGROUND

A user interface of a mobility apparatus (e.g., automobile) may be implemented with a hybrid input device that combines and uses a touch sensor and a tactile sensor unit for user convenience.

The touch sensor may detect a user’s contact and generate an input signal. The touch sensor may be, for example, a capacitive or resistive sensor. On the other hand, the tactile sensor may detect physical operations such as a press of a button and generate an input signal. The tactile sensor may provide users with certainty of input through tactile feedback such as a click sensation.

The hybrid input device in which the touch sensor and the tactile sensor are combined may output a switching signal when a physical operation is completed by a tactile input after a touch input is confirmed.

However, there is a problem in which such a switch apparatus may fail to output the switching signal when either the touch sensor or the tactile sensor breaks down. In particular, in an emergency situation, when there is a problem with either of the touch sensor or the tactile sensor, for example, and a moving component of the mobility apparatus, such as a window, a door, or a side door, fails to operate, it may seriously jeopardize the user’s safety.

The matters described in this Background section are only for enhancement of understanding of the background of the disclosure, and should not be taken as acknowledgement that they correspond to prior art already known to those skilled in the art.

### SUMMARY

The present disclosure is directed to providing a switch apparatus that allows a switch operation even when either a touch sensor or a tactile sensor unit fails, a mobility apparatus including the same, and a control method of a mobility apparatus.

According to one or more example embodiments of the present disclosure, a switching apparatus may include: a touch sensor configured to generate, based on receiving a touch input, a touch input signal; a tactile switch configured to generate, based on a physical movement of the tactile switch, a tactile input signal; and a control circuit connected to the touch sensor and the tactile switch. The control circuit may be configured to output a switching signal based on at least one of: receiving, within a first threshold time duration, at least a first threshold quantity of touch input signals from the touch sensor; receiving, within a second threshold time duration, at least a second threshold quantity of tactile input signals from the tactile switch; or receiving at least one tactile input signal from the tactile switch within a third threshold time duration after receiving at least one touch input signal from the touch sensor.

The switching apparatus may further include a housing configured to accommodate the touch sensor and the tactile switch. The touch sensor may be mounted, in the housing, to be movable between an undepressed position and a depressed position. The tactile switch may be coupled to the touch sensor to form a contact point when the touch sensor is depressed to be in the depressed position.

The touch sensor may include a first touch input area and a second touch input area different from the first touch input area. The control circuit may be configured to output the switching signal by generating at least one of: based on a first touch input being received at the first touch input area of the touch sensor, a first control signal; or, based on a second touch input being received at the second touch input area of the touch sensor, a second control signal different from the first control signal.

The control circuit may be configured to output the switching signal by: generating the switching signal based on receiving, within the second threshold time duration, at least the second threshold quantity of tactile input signals without receiving, within the second threshold time duration, any touch input signal from the touch sensor.

The switching signal may include a control signal for controlling a movement of at least one of: a side-view mirror of a vehicle, a window of the vehicle, or a door of the vehicle.

The control circuit may be configured to output the switching signal by: generating the switching signal based on receiving the second threshold quantity of tactile input signals at time intervals that are less than a threshold time interval.

The control circuit may be configured to output the switching signal by: based on receiving any two consecutive tactile input signals, of the second threshold quantity of tactile input signals, at a time interval that is greater than a threshold time interval, resetting a counter.

The second threshold quantity may be between 2 and 15 and the threshold time interval is between 0.5 second and 2 seconds.

The control circuit may be configured to output the switching signal by: generating the switching signal based on receiving, within the first threshold time duration, the at least the first threshold quantity of touch input signals without receiving, within the first threshold time duration, any tactile input signal from the tactile switch.

The touch sensor may include a plurality of touch input areas. The switching signal may include a control signal corresponding to a touch input area, of the plurality of touch input areas, at which touch inputs corresponding to the first threshold quantity of touch input signals are received within the first threshold time duration.

The control circuit may be configured to output the switching signal by: generating the switching signal based on receiving the first threshold quantity of touch input signals at time intervals that are less than a threshold time interval.

The control circuit may be configured to output the switching signal by: based on receiving any two consecutive touch input signals, of the first threshold quantity of touch input signals, at a time interval that is greater than a threshold time interval, resetting a counter.

The first threshold quantity may be between 2 and 15 and the threshold time interval is between 0.5 second and 2 seconds.

According to one or more example embodiments of the present disclosure, a mobility apparatus may include a switching apparatus. The switching apparatus may include: a touch sensor configured to generate, based on receiving a touch input, a touch input signal; a tactile switch configured to generate, based on a physical movement of the tactile switch, a tactile input signal; and a control circuit connected to the touch sensor and the tactile switch. The control circuit may be configured to output a switching signal based on at least one of: receiving, within a first threshold time duration, at least a first threshold quantity of touch input signals from the touch sensor; receiving, within a second threshold time duration, at least a second threshold quantity of tactile input signals from the tactile switch; or receiving at least one tactile input signal from the tactile switch within a third threshold time duration after receiving at least one touch input signal from the touch sensor.

According to one or more example embodiments of the present disclosure, a method may include: generating, by a control circuit of a switching apparatus, a switching signal based on at least one of: receiving, within a first threshold time duration and from a touch sensor of the switching apparatus, at least a first threshold quantity of touch input signals; receiving, within a second threshold time duration and from a tactile switch of the switching apparatus, at least a second threshold quantity of tactile input signals; or receiving at least one tactile input signal from the tactile switch within a third threshold time duration after receiving at least one touch input signal from the touch sensor; and outputting, by the control circuit, the switching signal. Each of the first threshold quantity of touch input signals may be generated, by the touch sensor, based on a corresponding touch input to the touch sensor. Each of the second threshold quantity of tactile input signals may be generated, by the tactile switch, based on a corresponding movement of the tactile switch.

Generating the switching signal may include: generating the switching signal based on receiving, within the second threshold time duration, at least the second threshold quantity of tactile input signals without receiving, within the second threshold time duration, any touch input signal from the touch sensor.

Generating the switching signal may include: generating the switching signal based on receiving the second threshold quantity of tactile input signals at time intervals that are less than a threshold time interval.

Generating the switching signal may include: generating the switching signal based on receiving, within the first threshold time duration, the at least the first threshold quantity of touch input signals without receiving, within the first threshold time duration, any tactile input signal from the tactile switch.

The touch sensor may include a plurality of touch input areas. The switching signal may include a control signal corresponding to a touch input area, of the plurality of touch input areas, at which touch inputs corresponding to the first threshold quantity of touch input signals are received within the first threshold time duration.

Generating the switching signal may include: generating the switching signal based on receiving the first threshold quantity of touch input signals at time intervals that are less than a threshold time interval.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a block diagram illustrating an example switch apparatus of a mobility apparatus;

FIG. 2 is a cross-sectional side view of an example switch apparatus;

FIG. 3 is a cross-sectional side view illustrating an example switch apparatus when a user presses a touch sensor;

FIG. 4 is a flowchart illustrating an example control method of a mobility apparatus;

FIG. 5 is a flowchart illustrating an example control method of a mobility apparatus to which a fail-safe process is applied;

FIG. 6 is a diagram illustrating an example process of generating a switching signal by the fail-safe process;

FIG. 7 is a flowchart illustrating an example process of generating a first switching signal by tactile input signals;

FIG. 8 is a diagram illustrating example tactile input signals that are received within a reference input time and are received a reference number of times;

FIG. 9 is a block diagram illustrating example operations of a mobility apparatus by a first switching signal;

FIG. 10 is a flowchart illustrating an example process of generating a second switching signal by touch input signals;

FIG. 11 is a diagram illustrating example touch input signals that are received within a reference input time and are received a reference number of times; and

FIG. 12 illustrates an example computing system.

### DETAILED DESCRIPTION

Since the present disclosure may be variously modified and may have one or more embodiments, one or more example embodiments thereof will be illustrated in the drawings and described. However, this is not intended to limit the present disclosure to one or more specific embodiments, and it should be understood to include all modifications, equivalents, and substitutes included in the spirit and scope of the present disclosure.

Although the terms including ordinal numbers such as second, first, or the like, may be used to describe various elements, these elements are not limited by these terms. These terms are only used to distinguish one element from another element. For example, without departing from the scope of the present disclosure, a second element could be termed a first element, and similarly, a first element could be termed a second element. The term “and/or” includes a combination of a plurality of related listed items or any of a plurality of related listed items.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are no intervening elements.

The terms used in the present application are merely provided to describe example embodiment(s), and are not intended to limit the present disclosure. The singular forms are intended to include the plural forms as well, unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

Unless otherwise defined, all terms used herein, including technical or scientific terms, have the same meaning as commonly understood by those of ordinary skill in the art to which the present disclosure belongs. Terms, such as those defined in commonly used dictionaries, should be interpreted as having a meaning that is consistent with their meaning in the context of the related technical field and will not be interpreted in an idealized or overly formal sense unless expressly so defined herein.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

As used herein, a mobility apparatus (also referred to as a mobility device) may refer to any apparatus, device, or vehicle that is capable of movement. A mobility apparatus may be capable of movement by means of self-propulsion using, for example, one or more motors or engines. A mobility apparatus may be capable of traversing over and/or across different terrains and spaces, such as land, underground, air, space, sea, and/or underwater. Land or underground mobility apparatuses may be provided, for example, in the form of vehicles (e.g., automobiles, cars, trucks, buses, motorcycles, mopeds, bicycles, mobility scooters, etc.) or robots. Air or space mobility apparatuses may be provided, for example, in the form of air mobility apparatuses, such as fixed-wing or rotary-wing aircraft, advanced air mobility (AAM) devices, unmanned aerial vehicles, drones, rockets, or vehicles mounted on satellites. Marine or underwater mobility devices 10 may include, for example, ships, boats, jet skis, hovercraft, submarines, etc. A mobility apparatus may move across multiple terrains or spaces.

Hereinafter, one or more example embodiments will be described in detail with reference to the accompanying drawings, but the same or corresponding components are denoted by the same reference numerals regardless of the drawing numbers, and redundant descriptions thereof will be omitted.

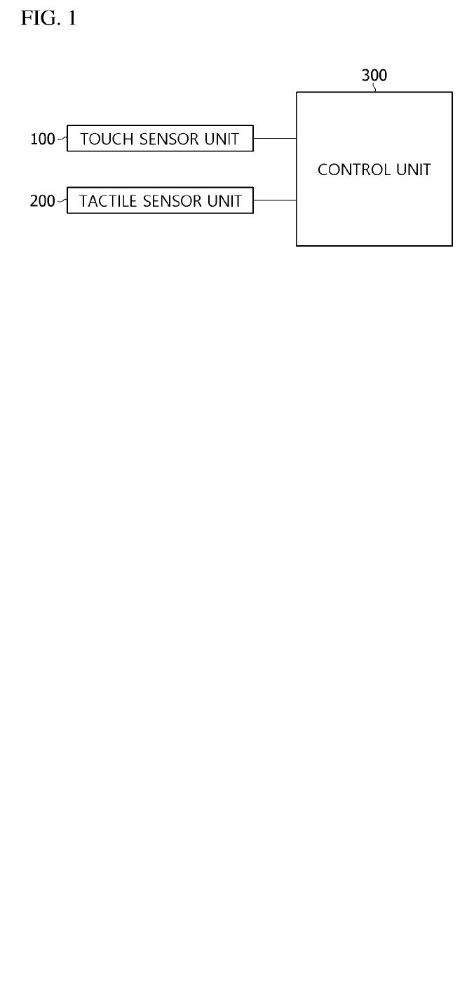

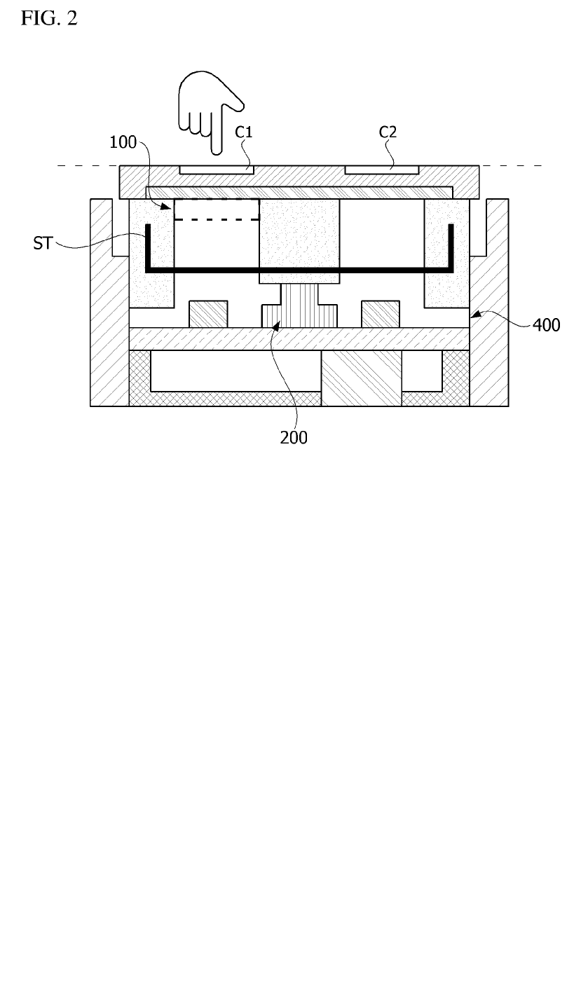

FIG. 1 is a block diagram illustrating an example switch apparatus of a mobility apparatus, and FIG. 2 is a cross-sectional side view of an example switch apparatus.

Referring to FIGS. 1 and 2, a switch apparatus (also referred to as a switching apparatus) of the mobility apparatus may include a touch sensor (also referred to as a touch sensor) 100, a tactile switch (also referred to as a tact switch or a tactile sensor) 200, and a control circuit (also referred to as a control unit) 300. The switch apparatus may have specified touch areas (also referred to as touch input areas) C1 and C2 included in the touch sensor 100 by a user’s touch and then confirming a function of the touch areas by a physical tact of the tactile switch 200.

The touch sensor 100 may form a plurality of touch areas C1 and C2. Touch input signals formed (e.g., generated) by each of the touch areas C1 and C2 may be switching signals that implement different operations in the mobility apparatus. The touch sensor 100 may, for example, generate a first touch input signal if the touch area C1 is activated (e.g., registers a touch input), and generate a second touch input signal, which may be different from the first touch input signal, if the touch area C2 is activated (e.g., registers a touch input). Different touch input signals may be used (e.g., by the control circuit 300) to cause different operations (e.g., functions). For example, here, operations implemented in the switching signal may be opening or closing of a window of a mobility apparatus, locking or unlocking of a door, movement of a side door, turning on or off of an air conditioner, and the like.

This touch sensor 100 may be mounted to be movable up and down (e.g., between a first position and a second position) inside a housing (also referred to as a case) 400. For example, the touch sensor 100 (e.g., the entire touch sensor 100 itself) may be in an undepressed position (e.g., default position, OFF position, or deactivated position) when not depressed, and be movable to a depressed position (e.g., ON position or activated position) when depressed by touch input. The touch sensor 100 may include a pad on which the touch areas C1 and C2 are formed and an electrode may be disposed under the pad. The touch sensor 100 may operate in a manner that detects a change in electrostatic capacitance by a user’s touch. Alternatively, the touch sensor 100 may operate through calculation of an electrical resistance value of a circuit that is touched by the user’s touch.

When a user presses the specific touch areas C1 and C2 of the touch sensor 100, the touch sensor 100 may move down by a pressing force of the user. When the touch sensor 100 moves, the physical force is applied to the tactile switch 200.

The tactile switch 200 may be connected to the touch sensor 100 and set to be turned on or off by the movement of the touch sensor 100. The tactile switch 200 may be mounted on the housing 400 and positioned under the touch sensor 100. The tactile switch 200 may form a contact point in conjunction with the downward physical operation of the touch sensor 100. When the tactile switch 200 is switched to an on state by the movement of the touch sensor 100, the control circuit 300 outputs a switching signal that implements a function corresponding to the touched specific touch areas C1 and C2. A physical connection portion between the tactile switch 200 and the touch sensor 100 may correspond to the center of the touch sensor 100.

The control circuit 300 may be connected to the touch sensor 100 and the tactile switch 200 to output a switching signal. The switching signal may be a signal (e.g., an electrical signal) that indicates that a switching device has been activated. The switching signal may, for example, signal ON, OFF, or toggle. An electrical signal may indicate a command and/or convey information to another device (e.g., the control circuit 300).

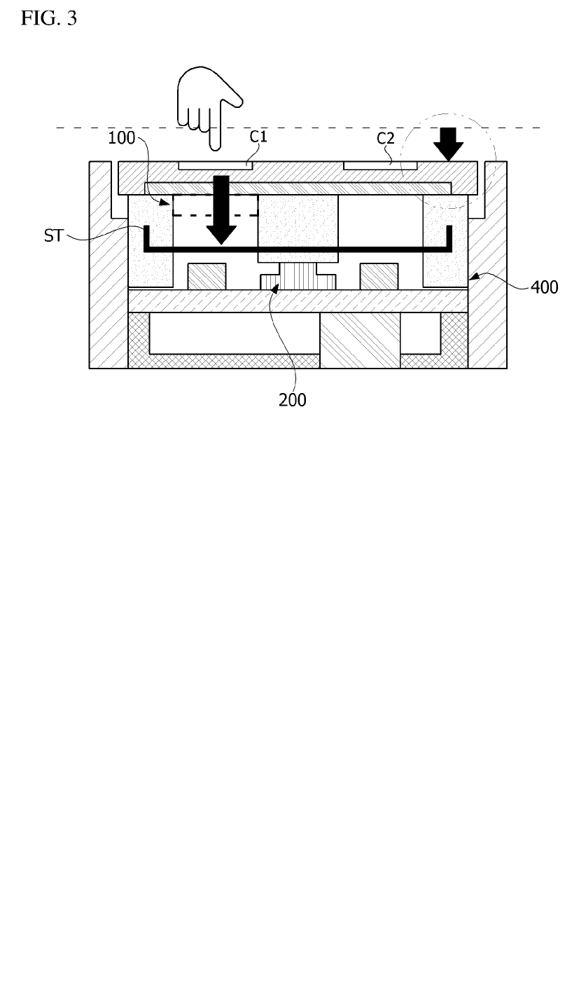

FIG. 3 is a cross-sectional side view illustrating an example switch apparatus when the user presses the touch sensor 100.

Referring to FIG. 3, if the user presses (e.g., pushes down on) the touch sensor 100, the touch sensor 100 may move (e.g., physically move) down and press down on (e.g., activate) the tactile switch 200. The touch sensor 100, when pressed (e.g., touched or activated), may generate a touch input signal to indicate that touch input has been received (e.g., registered) by the touch sensor 100. The touch input signal may be input to (e.g., received or detected by) the control circuit 300. If the tactile switch 200 is pressed (e.g., pressed down or activated), the tactile switch 200 may generate a tactile input signal (also referred to as a tactile signal or tact signal). A tactile input signal may be a signal (e.g., an electrical signal) that indicates that the tactile switch 200 has been activated (e.g., pressed down) by tactile input (e.g., by a user’s press of the tactile switch 200. An electrical signal may indicate a command and/or convey information to another device (e.g., the control circuit 300). The tactile switch 200 may generate the tactile input signal based on a physical movement of the tactile switch 200 caused by the user’s tactile input. For example, the tactile switch 200 may include two electrical contacts. A user’s tactile input (e.g., a button press) may move (e.g., physically move) one of the electrical contacts to come in contact with the other electrical contact to complete an electrical circuit (e.g., activate an electrical switch), and the tactile input signal may be generated as a result. The tactile switch 200 may be, for example, a button, a push button, a toggle button, a cycle button, etc. The tactile switch 200 may be, for example, a biased switch having a mechanism (e.g., a spring) that springs it into a default position (e.g., undepressed position, OFF position, or deactivated position) when the pressure applied by an operator (e.g., user) is removed or released. In other words, after the operator depresses the tactile switch 200 (e.g., to its depressed position, ON position, or activated position) and releases the tactile switch 200, the mechanism (e.g., a spring) may return the tactile switch 200 to its default position (e.g., undepressed position, OFF position, or deactivated position). As a result, the touch sensor 100 may also return to its default position (e.g., undepressed position, OFF position, or deactivated position). If the tactile switch 200 is pressed and the tactile input signal is generated while the touch input signal is also being input (e.g., to the control circuit 300, the touch input signal may be confirmed (e.g., validated) and a switching signal corresponding thereto may be generated.

The touch sensor 100 may be connected to a stabilizer ST. The stabilizer ST may connect one side and the other side of the touch sensor 100, so that even when the specific touch areas C1 and C2 that are biased from the center are pressed among a plurality of contact areas, the touch sensor 100 is guided to apply a stable physical force to the tactile switch 200.

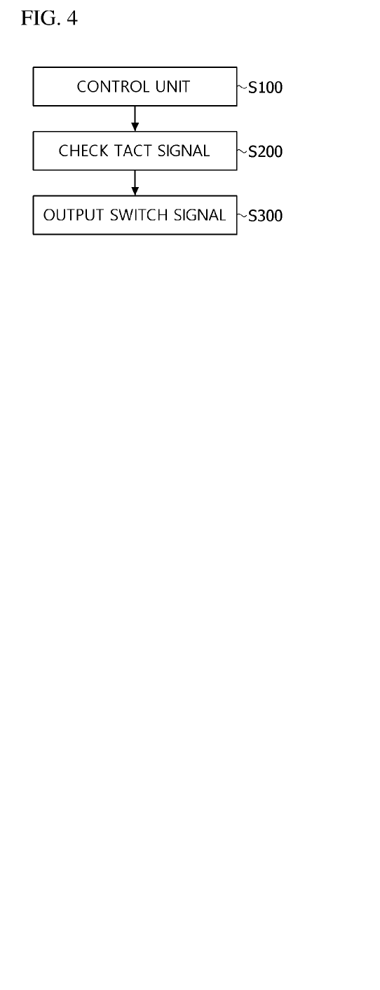

FIG. 4 is a flowchart illustrating an example control method of a mobility apparatus. Referring to FIGS. 4, in the control method of a mobility apparatus, the control circuit 300 checks an input of a touch input signal (also referred to as a touch signal) (S100). A touch input signal may be a signal (e.g., an electrical signal) that indicates that touch input has been received (e.g., registered) by the touch sensor 100. An electrical signal may indicate a command and/or convey information to another device (e.g., the control circuit 300). Depending on the location of the specific area touched by the user, a touch input signal may trigger the control circuit 300 to perform a different operation. The control circuit 300 may check for the touch input signal to perform an appropriate action.

Next, when the input of the touch input signal is checked, the control circuit 300 checks an input of a tactile input signal (S200).

Next, when the input of the tactile input signal is checked, the input touch input signal is finally checked and the control circuit 300 outputs a switching signal (S300).

If a tactile input signal from the tactile switch 200 is received or detected (e.g., by the control circuit 300) while the touch input signal is present through the touch sensor 100, the control circuit 300 may confirm (e.g., validate) the touch input signal and generate a switching signal corresponding thereto. However, if an abnormality (e.g., malfunction, etc.) occurs in the touch sensor 100 or the tactile switch 200 and no tactile input signal or touch input signal can be generated even if the user touches or presses down on the touch sensor 100, it may still be necessary to generate the switching signal.

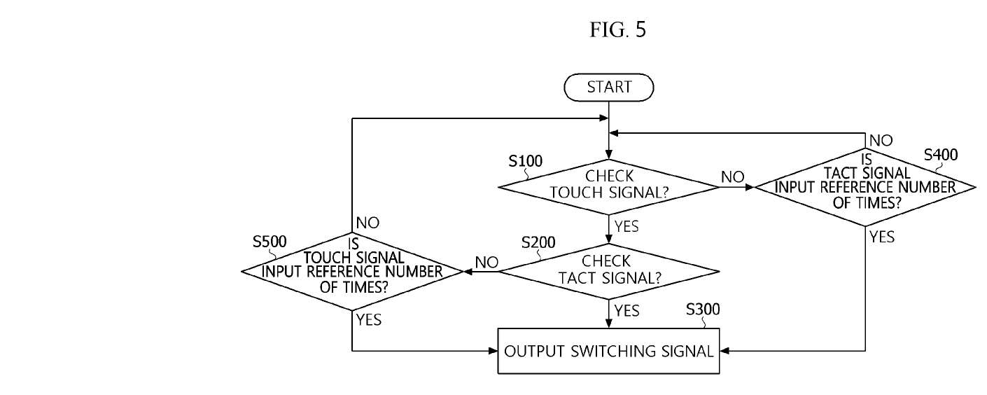

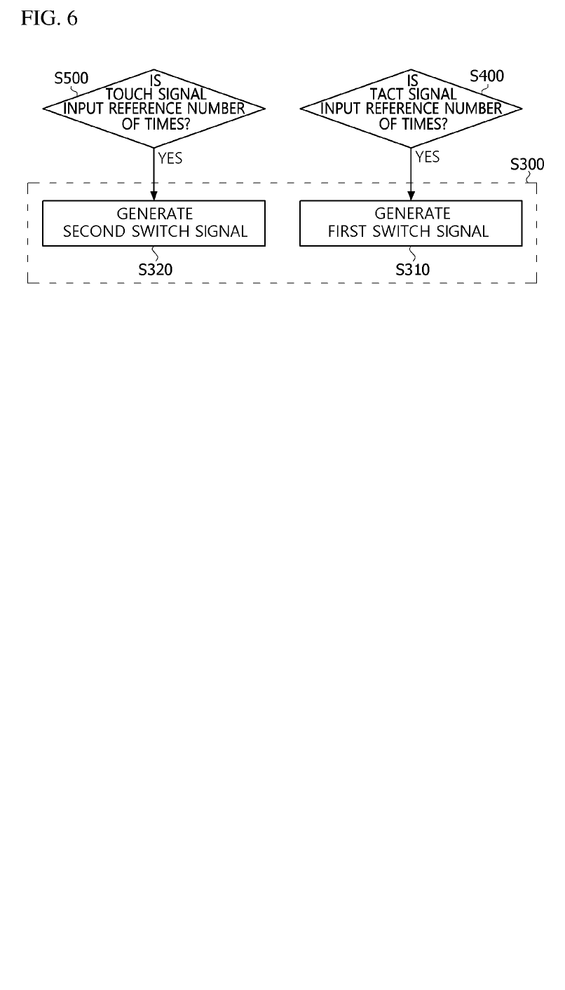

FIG. 5 is a flowchart illustrating an example control method of a mobility apparatus to which a fail-safe process is applied, and FIG. 6 is a diagram illustrating an example process of generating a switching signal by the fail-safe process.

Referring to FIGS. 5 and 6, if a user touches (e.g., presses) the touch areas C1 and C2 no touch input signal may be generated or input due to a failure of the touch sensor 100. Depending on the situation, when the function corresponding to the touch areas C1 and C2 is not operated, a user’s safety may be threatened. The control method of a mobility apparatus is a fail-safe process in preparation for such a case, and may generate a switching signal under a certain condition even when the touch input signal is not input.

The control circuit 300 may generate a first switching signal corresponding to the touch input signal if the tactile input signal is received a reference number of times (also referred to as a threshold quantity) within a reference time, even when the touch input signal is not input.

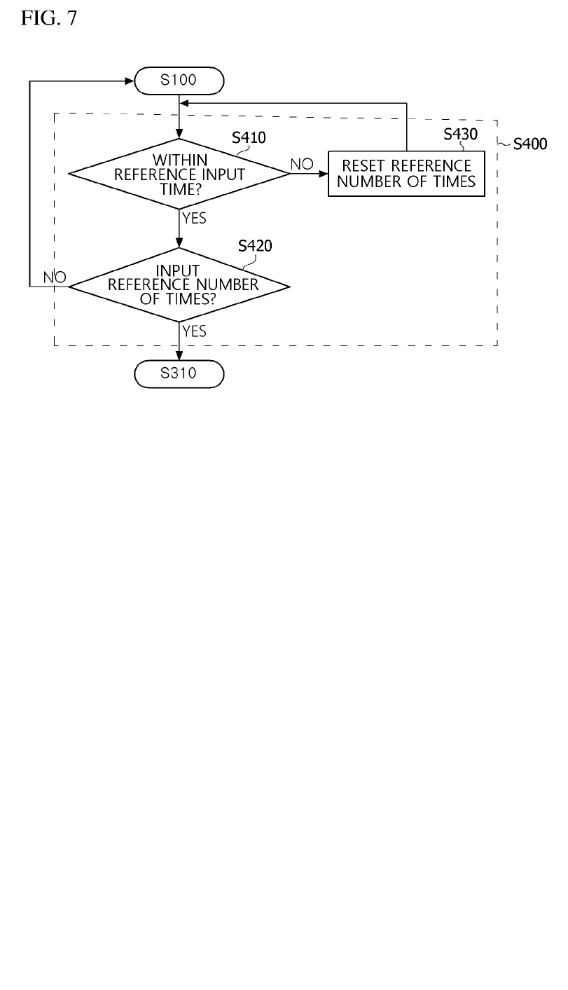

FIG. 7 is a flowchart illustrating an example process of generating a first switching signal by tactile input signals.

Referring to FIGS. 6 and 7, the control circuit 300 checks whether the tactile input signals are input (e.g., received) a reference number of times in a state where there is no touch input signal (S400).

Specifically, the control circuit 300 checks whether the tactile input signals are received (e.g., by the control circuit 300) within a reference input time (S410). The reference input time corresponds to a time in which a next tactile input signal has to be received after a previous tactile input signal is received. If the tactile input signals are received within the reference input time, the control circuit 300 counts the tactile input signals within the reference input time and determines whether the reference number of times is reached (S420).

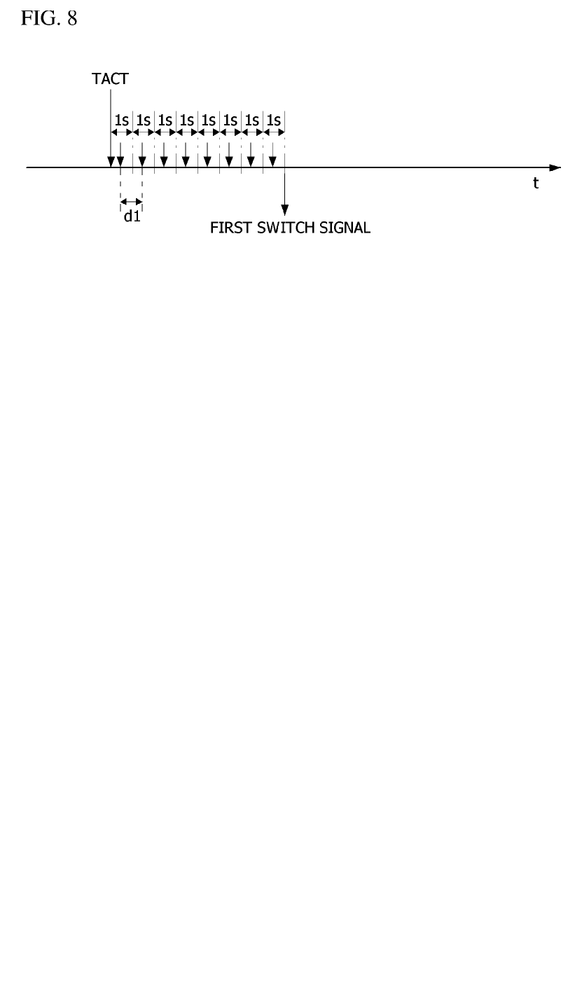

FIG. 8 is a diagram illustrating example tactile input signals that are received within a reference input time (e.g., a threshold time duration or amount) and are received a reference number of times. The reference number can be any number above 1 (e.g., between 2 and 15). The reference input time may be, for example, any value between 0.5 second and 2 seconds.

Referring to FIG. 8, when t in the drawing represents a time axis, for example, when a reference number of times is 9 and the reference input time is 1 second (s), a second tactile input signal has to be input within 1 second after a first tactile input signal is received. Then, after the second tactile input signal is received, a third tactile input signal also has to be input within the reference input time of 1 second. When a total of 9 tactile input signals is received through this process, the control circuit 300 generates a first switching signal. In this case, intervals d1 at which the tactile input signals are received during the input of the 9 tactile input signals may be different from each other as long as the intervals are within 1 second. Although the reference number of times is exemplified as 9 times, the present disclosure is not limited thereto and may be changed to various numbers of times.

If an N-th tactile input signal is received after the reference input time (e.g., 1 second) elapses since the immediately preceding tactile input signal is received, the control circuit 300 may reset the counting of the reference number of times and check whether a tactile input signal is received again within the reference input time (S410). For example, the control circuit 300 may increment a counter (e.g., a counter for counting how many tactile input signals have been received) every time the control circuit 300 receives a tactile input signal. If any two consecutive receptions of the tactile input signal is above a threshold time interval (e.g., a reference input time), the control circuit 300 may reset the counter (e.g., to zero). Thus, the counter may count how many consecutive tactile input signals have been received at intervals below the threshold time interval (e.g., reference input time).

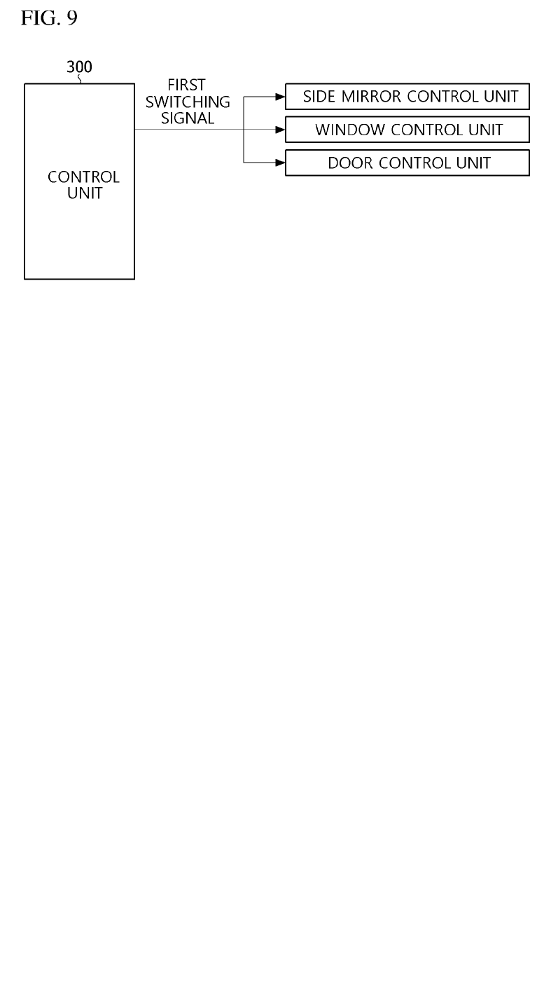

FIG. 9 is a block diagram illustrating example operations of a mobility apparatus by a first switching signal.

Referring to FIG. 9, a control circuit 300 may generate the first switching signal based on repeated tactile input signals without a touch input signal. For example, the first switching signal may be a control signal that controls a side-view mirror control circuit, a window control circuit, a door control circuit, or the like of a mobility apparatus. When starting or stopping the mobility apparatus in a state where the touch sensor 100 fails, a user may fold or unfold the side-view mirror by pressing the tactile switch 200 a reference number of times. Alternatively, the position of the side-view mirrors may be adjusted.

In particular, in emergency situations, the operation of mobility apparatus may be ensured, thereby securing the safety of the user. For example, in emergency situations such as rain, fire, or flooding, the opening and closing of windows and doors of the mobility apparatus may be controlled to secure the safety of the user.

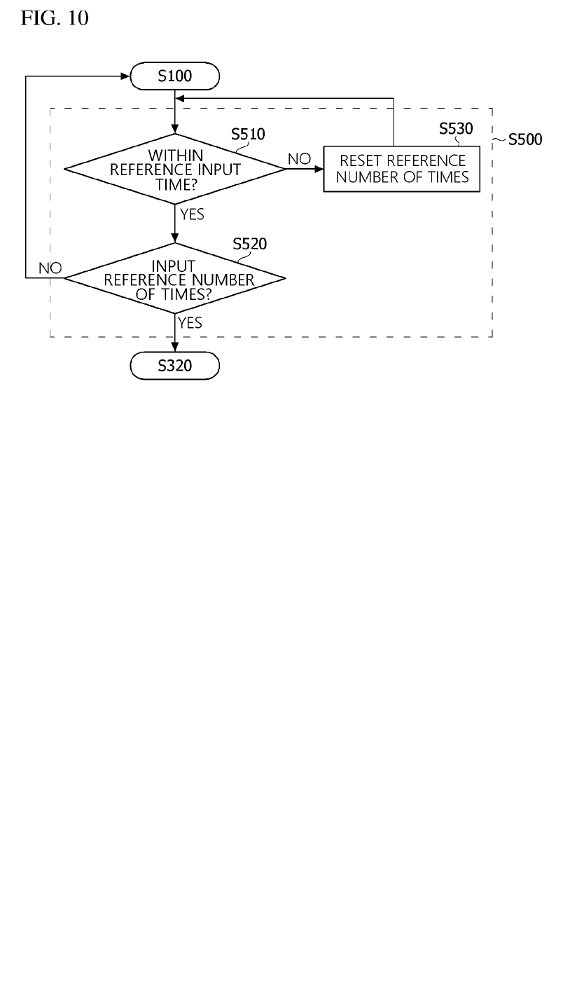

FIG. 10 is a flowchart illustrating an example process of generating a second switching signal by touch input signals.

Referring to FIGS. 6 and 10, the control circuit 300 checks whether touch input signals are received (e.g., by the control circuit 300) a reference number of times when the touch input signals are received but tactile input signals are not input (S500).

Specifically, the control circuit 300 checks whether touch input signals are received within a reference input time (also referred to as a reference input time duration or a threshold time duration or amount) (S510). The reference input time may correspond to a time (e.g., time duration) within which a next touch input signal must be input (e.g., received by the control circuit 300) after a touch input signal (e.g., previous touch input signal) is input (e.g., received by the control circuit 300). If the touch input signals are received within the reference input time, the control circuit 300 may count the touch input signals within the reference input time (e.g., increment a touch input signal counter) and determine whether the reference number of times is reached (S520).

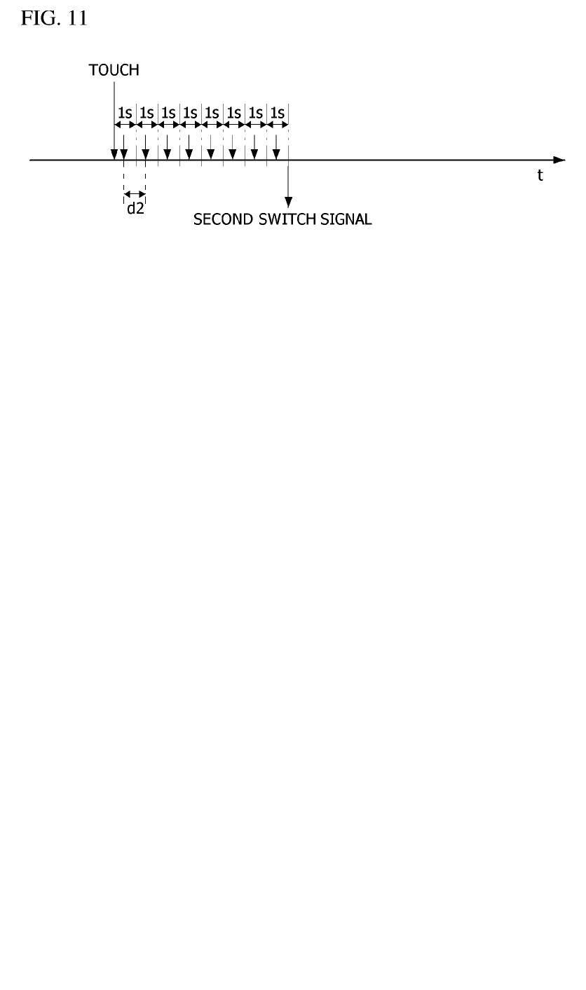

FIG. 11 is a diagram illustrating example touch input signals that are received within a reference input time and are received a reference number of times. The reference number can be any number above 1 (e.g., between 2 and 15). The reference input time may be, for example, any value between 0.5 second and 2 seconds.

Referring to FIG. 11, when t in the drawing represents a time axis, for example, when a reference number of times is 9 and the reference input time is 1 second (s), a second touch input signal has to be input within 1 second after a first touch input signal is received. Then, after the second touch input signal is received, a third touch input signal also has to be input within the reference input time (e.g., 1 second). When a total of 9 touch input signals is received through this process, the control circuit 300 generates a second switching signal. In this case, intervals d2 at which the touch input signals are received during the input of the 9 touch input signals may be different from each other as long as the intervals are within the reference input time (e.g., 1 second).

If an N-th touch input signal is input (e.g., received by the control circuit 300) after the reference input time (e.g., 1 second) elapses since the immediately preceding touch input signal is received, the control circuit 300 may reset the counting of the reference number of times and check whether a touch input signal is received again within the reference input time (S530). For example, the control circuit 300 may increment a counter (e.g., a counter for counting how many touch input signals have been received) every time the control circuit 300 receives a touch input signal. If any two consecutive receptions of the touch input signal is above a threshold time interval (e.g., a reference input time), the control circuit 300 may reset the counter (e.g., to zero). Thus, the counter may count how many consecutive touch input signals have been received at intervals below the threshold time interval (e.g., reference input time).

In this way, the control circuit 300 may generate the second switching signal based on repeated touch input signals without a tactile input signal. The second switching signal may be a control signal for performing a function corresponding to touch areas C1 and C2 repeatedly touched by the user. The second switching signal may be a control signal for various applications operating in a mobility apparatus.

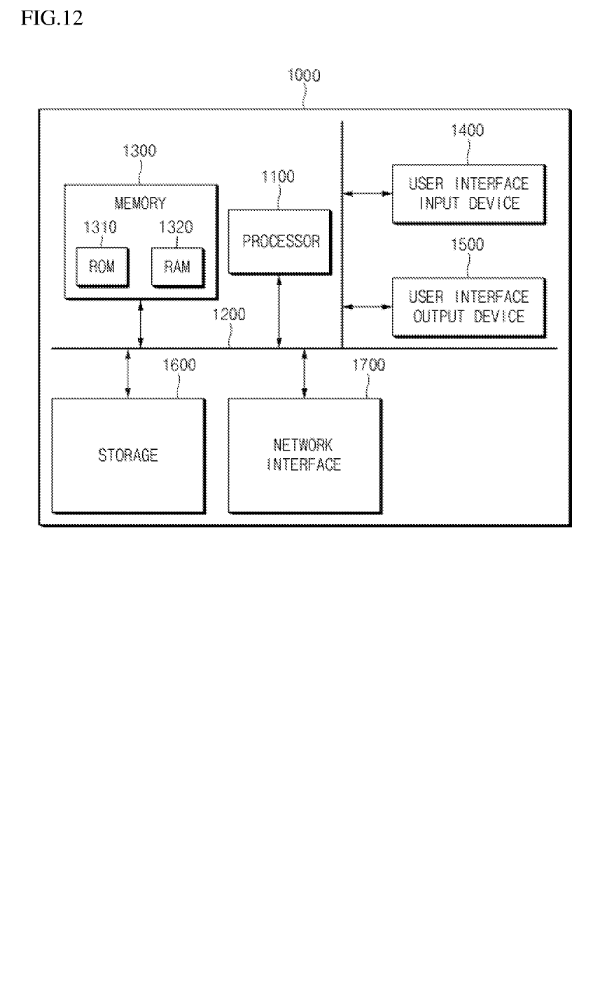

FIG. 12 illustrates an example computing system (e.g., a computing device of a mobility apparatus, such as a vehicle, or any other apparatus). One or more controllers, processors, etc. described herein may be implemented by the computing system or may be implemented in the computing system.

A computing system (also referred as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

There is provided a switch apparatus including a touch sensor unit configured to generate a touch signal, a tactile sensor unit configured to generate a tact signal, and a control unit connected to the touch sensor unit and the tactile sensor unit, in which the control unit outputs a switch signal on the premise that the tact signal is input after the touch signal is input, and the control unit generates the switch signal when at least one of the touch signal and the tact signal is input a reference number of times within a reference time even when both the touch signal and the tact signal are not input.

The switch apparatus may further include a case configured to accommodate the touch sensor unit and the tactile sensor unit, in which the touch sensor unit may be disposed in the case to be pressurizable, and the tactile sensor unit may be connected to the touch sensor unit to form a contact point when the touch sensor unit is pressed.

The touch sensor unit may include a plurality of touch areas, and touch signals formed by the plurality of touch areas may be switch signals for implementing different operations.

The control unit may generate a first switch signal when the tact signal is input a reference number of times within a reference time without the touch signal.

The first switch signal may be any one of a control signal for moving a side mirror of a mobility apparatus, a control signal for opening and closing a window of the mobility apparatus, and a control signal for opening and closing a door of the mobility apparatus.

The control unit may generate the first switch signal only when all of intervals at which the tact signal is input are within a reference input time while the tact signal is input the reference number of times.

The control unit may reset the counting of the reference number of times when at least one of intervals at which the tact signal is input exceeds a reference input time while the tact signal is input the reference number of times.

The reference number of times may be 9, and the reference input time may be 1 second.

The control unit may generate a second switch signal when the touch signal is input the reference number of times within the reference time without the tact signal.

The touch sensor unit may include a plurality of touch areas, and when the touch signal is input to any one of the plurality of touch areas the reference number of times within the reference time, the second switch signal may be a control signal corresponding to the touch area.

The control unit may generate the second switch signal only when all of intervals at which the touch signal is input are within a reference input time while the touch signal is input the reference number of times.

The control unit may reset the counting of the reference number of times when at least one of intervals at which the tact signal is input exceeds a reference input time while the tact signal is input the reference number of times.

The reference number of times may be 9, and the reference input time may be 1 second.

There is provided a mobility apparatus including a switch apparatus, in which the switch apparatus includes a touch sensor unit configured to generate a touch signal, a tactile sensor unit configured to generate a tact signal, and a control unit connected to the touch sensor unit and the tactile sensor unit, the control unit outputs a switch signal on the premise that the tact signal is input after the touch signal is input, and the control unit generates the switch signal when at least one of the touch signal and the tact signal is input a reference number of times within a reference time even when both the touch signal and the tact signal are not input.

There is provided a control method of a mobility apparatus including a touch signal checking operation of checking an input of a touch signal, a tact signal checking operation of checking an input of a tact signal when the input of the touch signal is checked, and a switch signal outputting operation of outputting a switch signal when the input of the touch signal is checked and the input of the tact signal is checked, in which in the switch signal outputting operation, the switch signal is generated when at least one of the touch signal and the tact signal is input a reference number of times within a reference time even when both the touch signal and the tact signal are not input.

The control unit may generate a first switch signal when the tact signal is input a reference number of times within a reference time without the touch signal.

The first switch signal may be generated only when all of intervals at which the tact signal is input are within a reference input time while the tact signal is input the reference number of times.

The control unit may generate a second switch signal when the touch signal is input the reference number of times within the reference time without the tact signal.

When the touch signal is input to any one of a plurality of touch areas the reference number of times within the reference time, the second switch signal may be a control signal corresponding to the touch area.

The second switch signal may be generated only when all of intervals at which the touch signal is input are within a reference input time while the touch signal is input the reference number of times.

There is an advantage in that switch operation is possible even when either the touch sensor or the tactile switch fails.

Although one or more example embodiments of the present disclosure have been described above, it is understood that those skilled in the art can make various changes and modifications to the present disclosure without departing from the spirit and scope of the present disclosure set forth in the claims below.

What is claimed is:

1. A switching apparatus comprising:
a touch sensor configured to generate, based on receiving a touch input, a touch input signal;
a tactile switch configured to generate, based on a physical movement of the tactile switch, a tactile input signal; and
a control circuit connected to the touch sensor and the tactile switch, wherein the control circuit is configured to output a switching signal based on at least one of:
receiving, within a first threshold time duration, at least a first threshold quantity of touch input signals from the touch sensor;
receiving, within a second threshold time duration, at least a second threshold quantity of tactile input signals from the tactile switch; or
receiving at least one tactile input signal from the tactile switch within a third threshold time duration after receiving at least one touch input signal from the touch sensor.

2. The switching apparatus of claim 1, further comprising a housing configured to accommodate the touch sensor and the tactile switch,
wherein the touch sensor is mounted, in the housing, to be movable between an undepressed position and a depressed position, and
wherein the tactile switch is coupled to the touch sensor to form a contact point when the touch sensor is depressed to be in the depressed position.

3. The switching apparatus of claim 1, wherein the touch sensor comprises a first touch input area and a second touch input area different from the first touch input area, and
wherein the control circuit is configured to output the switching signal by generating at least one of:
based on a first touch input being received at the first touch input area of the touch sensor, a first control signal; or
based on a second touch input being received at the second touch input area of the touch sensor, a second control signal different from the first control signal.

4. The switching apparatus of claim 1, wherein the control circuit is configured to output the switching signal by:
generating the switching signal based on receiving, within the second threshold time duration, at least the second threshold quantity of tactile input signals without receiving, within the second threshold time duration, any touch input signal from the touch sensor.

5. The switching apparatus of claim 1, wherein the switching signal comprises a control signal for controlling a movement of at least one of: a side-view mirror of a vehicle, a window of the vehicle, or a door of the vehicle.

6. The switching apparatus of claim 1, wherein the control circuit is configured to output the switching signal by:
generating the switching signal based on receiving the second threshold quantity of tactile input signals at time intervals that are less than a threshold time interval.

7. The switching apparatus of claim 1, wherein the control circuit is configured to output the switching signal by:
based on receiving any two consecutive tactile input signals, of the second threshold quantity of tactile input signals, at a time interval that is greater than a threshold time interval, resetting a counter.

8. The switching apparatus of claim 7, wherein the second threshold quantity is between 2 and 15 and the threshold time interval is between 0.5 second and 2 seconds.

9. The switching apparatus of claim 1, wherein the control circuit is configured to output the switching signal by:
generating the switching signal based on receiving, within the first threshold time duration, the at least the first threshold quantity of touch input signals without receiving, within the first threshold time duration, any tactile input signal from the tactile switch.

10. The switching apparatus of claim 1, wherein the touch sensor comprises a plurality of touch input areas, and
wherein the switching signal comprises a control signal corresponding to a touch input area, of the plurality of touch input areas, at which touch inputs corresponding to the first threshold quantity of touch input signals are received within the first threshold time duration.

11. The switching apparatus of claim 1, wherein the control circuit is configured to output the switching signal by:
generating the switching signal based on receiving the first threshold quantity of touch input signals at time intervals that are less than a threshold time interval.

12. The switching apparatus of claim 1, wherein the control circuit is configured to output the switching signal by:
based on receiving any two consecutive touch input signals, of the first threshold quantity of touch input signals, at a time interval that is greater than a threshold time interval, resetting a counter.

13. The switching apparatus of claim 12, wherein the first threshold quantity is between 2 and 15 and the threshold time interval is between 0.5 second and 2 seconds.

14. A mobility apparatus comprising:
a switching apparatus comprising:
a touch sensor configured to generate, based on receiving a touch input, a touch input signal;
a tactile switch configured to generate, based on a physical movement of the tactile switch, a tactile input signal; and
a control circuit connected to the touch sensor and the tactile switch,
wherein the control circuit is configured to output a switching signal based on at least one of:
receiving, within a first threshold time duration, at least a first threshold quantity of touch input signals from the touch sensor;
receiving, within a second threshold time duration, at least a second threshold quantity of tactile input signals from the tactile switch; or
receiving at least one tactile input signal from the tactile switch within a third threshold time duration after receiving at least one touch input signal from the touch sensor.

15. A method comprising:
generating, by a control circuit of a switching apparatus, a switching signal based on at least one of:
receiving, within a first threshold time duration and from a touch sensor of the switching apparatus, at least a first threshold quantity of touch input signals, wherein each of the first threshold quantity of touch input signals is generated, by the touch sensor, based on a corresponding touch input to the touch sensor;
receiving, within a second threshold time duration and from a tactile switch of the switching apparatus, at least a second threshold quantity of tactile input signals, wherein each of the second threshold quantity of tactile input signals is generated, by the tactile switch, based on a corresponding movement of the tactile switch; or
receiving at least one tactile input signal from the tactile switch within a third threshold time duration after receiving at least one touch input signal from the touch sensor; and
outputting, by the control circuit, the switching signal.

16. The method of claim 15, wherein the generating of the switching signal comprises:
generating the switching signal based on receiving, within the second threshold time duration, at least the second threshold quantity of tactile input signals without receiving, within the second threshold time duration, any touch input signal from the touch sensor.

17. The method of claim 15, wherein the generating of the switching signal comprises:
generating the switching signal based on receiving the second threshold quantity of tactile input signals at time intervals that are less than a threshold time interval.

18. The method of claim 15, wherein the generating of the switching signal comprises:
generating the switching signal based on receiving, within the first threshold time duration, the at least the first threshold quantity of touch input signals without receiving, within the first threshold time duration, any tactile input signal from the tactile switch.

19. The method of claim 15, wherein the touch sensor comprises a plurality of touch input areas, and wherein the switching signal comprises a control signal corresponding to a touch input area, of the plurality of touch input areas, at which touch inputs corresponding to the first threshold quantity of touch input signals are received within the first threshold time duration.

20. The method of claim 15, wherein the generating of the switching signal comprises:
generating the switching signal based on receiving the first threshold quantity of touch input signals at time intervals that are less than a threshold time interval.
